(19) United States
(12) Patent Application Publication
(10) Pub. No.: US 2010/0073399 A1
(43) Pub. Date: Mar. 25, 2010

(54) Methods and devices for controlling a presentation of an object

(75) Inventor: Johan APELQVIST, Hjarup (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/235,810

(22) Filed: Sep. 23, 2008

(51) Int. Cl. G09G 5/00

(52) U.S. Cl. 345/619

(57) ABSTRACT

A first communication device may include a control unit to determine a first image of an object to be used in generating a multi-dimensional representation. The multi-dimensional representation may be set in at least two states, each representing an expression and to be controlled by commands. Furthermore, the control unit may determine a second image to be used in the process and determine whether the second image is associated with the first image; analyze the second image to determine a first expression of the second image; and create an expression command based on the first expression. The expression command may be used to control the multi-dimensional representation to be set in a first state presenting the determined first expression.

### TECHNICAL FIELD

The invention generally relates to methods and devices in a communications network and, more particularly, to controlling a presentation of an object.

### BACKGROUND

In the field of telecommunications, various ancillary services are combined in user equipment to add functionality/versatility to the user experience. User equipment is constantly being designed in reduced sizes to appeal to users' tastes and increased processor capacity to accommodate services/functionalities that require attendant increased processor power. Exemplary services that are provided include chat services, graphical services, and the like. Graphical services require a relatively large processor capacity and fewer services and/or functionalities may then be provided as a result.

### SUMMARY

Embodiments of the invention described herein provide an efficient way to provide services/functionalities within a communications network.

In some embodiments, a method in a first communication device for controlling the presentation of a first object is disclosed. The method may include determining a first image of a first object to be used in creating a multi-dimensional representation of the first object. The multi-dimensional representation may be enabled to be set in at least two states, each of which may represent an expression and be controlled by commands.

The method may also include determining a second image of a second object that is to be used, and determining that the second object in the second image is associated with the first object in the first image. Under these circumstances, the method may analyze the second image to determine a first expression of the second object and create an expression command based on the first expression. The expression command may then be used to control the multi-dimensional representation to be set in a first state presenting the first expression.

To perform one or more of the above-described method, a first communication device is disclosed. The first communication device may include a control unit configured to determine a first image of an object to be used in a multi-dimensional representation. The multi-dimensional representation may be enabled to be set in at least two states each representing an expression and to be controlled by commands.

The control unit may also be configured to determine a second image to use and whether the second image is associated with the first image. In these circumstances, the control unit may be configured to analyze the second image to determine a first expression of the second image and to create an expression command based on the first expression. The expression command may be configured to be used to control the multi-dimensional representation to be set in a first state presenting the determined first expression.

In some embodiments, a method in a second communication device within a communications network for presenting a first state of a first object is disclosed. The method may include receiving image data of a first object, the image data being used to present a multi-dimensional representation of the first object enabled to be set in at least two states each representing an expression and to be controlled by commands.

The method may also include receiving an expression command associated with the image data and determining that the expression command is associated with the image data. The expression command may be used to control the multi-dimensional representation from the image data to be set in a state representing an expression.

To perform one or more of the above-described method, a second communication device is provided. The second communication device may include a receiving arrangement configured to receive image data of a first object from a first communication device. The image data may be used to present a multi-dimensional representation of the first object enabled to be set in at least two states each representing an expression and to be controlled by commands.

The receiving arrangement may also be configured to receive an expression command associated with the image data and the second communication device may also include a control unit configured to determine that the received expression command is associated with the image data and to use the expression command to control the state of the multi-dimensional representation from the image data.

### BRIEF DESCRIPTION OF THE DRAWINGS

Embodiments will now be described in more detail in relation to the enclosed drawings, in which:

FIG. 1 shows a schematic overview of a first communication device communicating with a second communication device;

FIG. 2 shows a combined signalling and method scheme of a method;

FIG. 3 shows a schematic flow chart of a method in a first communication device to control a state of a representation of an object;

FIG. 4 shows embodiments of the method in FIG. 3;

FIG. 5 shows a schematic overview of a first communication device;

FIG. 6 shows a schematic flow chart of a method in a second communication device to control a state of a representation of an object; and

FIG. 7 shows a schematic overview of a second communication device.

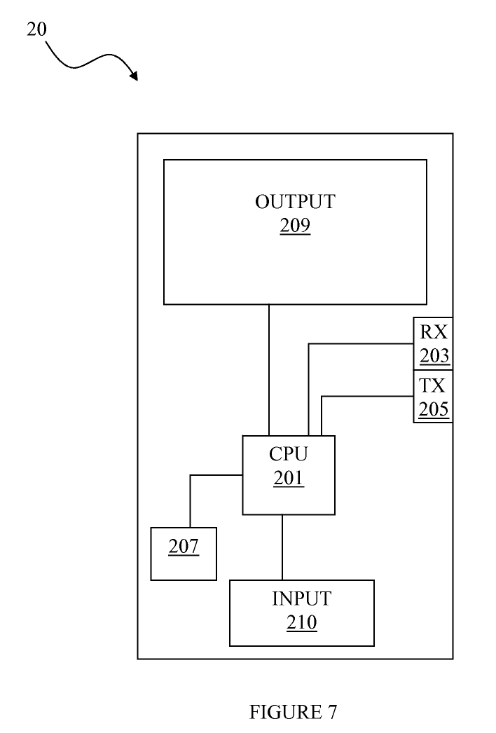

### DETAILED DESCRIPTION OF EMBODIMENTS

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure might be thorough and complete, and will fully convey the scope of the invention to those skilled in the art. Like numbers may refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, and/or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific examples (i.e., a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein as employed in and with a communication device, also denoted as user equipment. In the context of the invention, the communication device may be wireless device, e.g., a mobile phone, a PDA (personal digital assistant), or any other type of portable computer such as laptop computer. In some embodiments, a communication device may include a server/computer within a communications network.

The communications network may include any networks, such as CDMA, WCDMA, LTE, eLTE, GPRS, and/or the like.

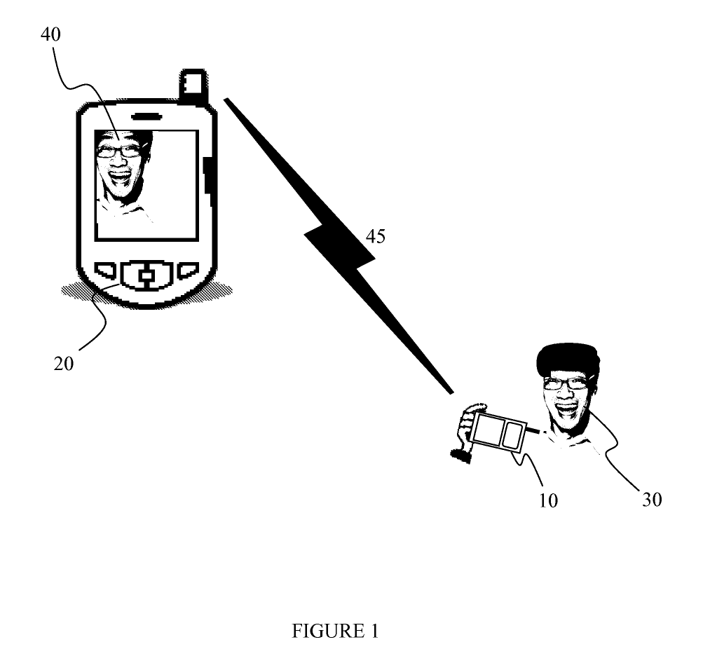

In FIG. 1, a schematic overview of a first user 30 communicating with a second user (not shown) in a communications network 45 is shown.

First user 30 in the illustrated example may have first user equipment 10, such as a mobile phone or the like, with camera functionality. First user equipment 10 may be in contact with second user equipment 20 via communications network 45 in an application, for example, a graphical chat application, in which first user 30 may be graphically presented in second user equipment 20 as a graphical representation 40.

In practice, first user equipment 10 may record a first image of an object, in the illustrated example, first user 30. First user equipment 10 may generate a three-dimensional model of first user 30 and transmit the three-dimensional model to second user equipment 20. The three-dimensional (3-D) model may be displayed in the graphical chat application of second user equipment 20. The first and second users of first and second user equipment 10, 20 may communicate (e.g., chat) with each other.

First user 30 may record a second image of himself using the camera functionality of first user equipment 10. First user equipment 10 may recognize the object in the second image as being the same as the object in the first image and an application within first user equipment 10 may determine an expression of first user 30, for example, that the object is smiling, in the second image.

First user equipment 10 may create an expression command, such as a document indicating image data changes representing a facial expression or the like, based on the determined expression and transmits the expression command via communications network 45 to second user equipment 20.

Second user equipment 20 may receive the expression command, read the expression command, and change the displayed three-dimensional model to a state expressing a smile.

Embodiments of the invention may disclose a service of making one photo of a face into a 3-D model that can be controlled by commands to smile, cry, look in different directions, change expressions, etc., combined with a technology that recognizes faces and expression of faces in a picture (still or from live camera). The combination may create a lightweight emoticon of oneself on, for example, user equipment of other users.

Embodiments of the invention may disclose techniques to control an emoticon, represented by a 3-D model motion portrait. This could be implemented in chat applications where moods are a vital part of expressing feelings. The parties may be provided with 3-D Motion portrait models or similar graphic renderings, representing an avatar of a user, of the other participants' avatars and the mood of the avatars may be controlled by using a device camera of the user equipment. Since embodiments of the invention disclose that the control of the avatar may be accomplished with commands, instead of sending the complete model, the participants may be provided a rich graphical experience to a low network cost.

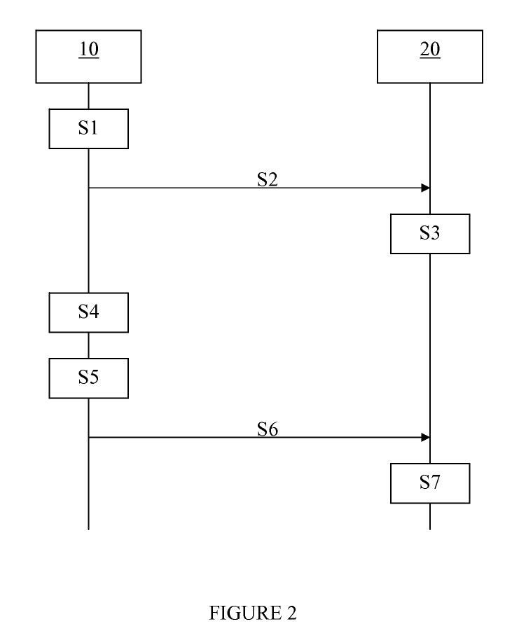

In FIG. 2, a schematic combined method and signaling scheme of an embodiment is shown.

In step S1, first communication device 10 may generate a multi-dimensional representation of a first image of an object. The multi-dimensional representation may be enabled to be set in at least two states, each representing an expression.

The first image may be an image recorded by first communication device 10 or a selected image from a library of stored images within or obtainable by first communication device 10, also expressed as ways of determining a first image.

In step S2, the multi-dimensional representation may be transmitted to second communication device 20.

In step S3, second communication device 20 may display the multi-dimensional representation.

In step S4, first communication device 10 may record a second image of a second object. It should here be understood that the second image may be selected from a library of images stored within or obtainable by first communication device 10; also expressed as ways of determining a second image.

In step S5, first communication device 10 may determines if the second object in the second image is associated with the first object in the first image and determine an expression of the second object in the second image by analyzing the second image. First communication device 10 may creates an expression command representing the determined expression.

In step S6, first communication device 10 may transmit the expression command to second communication device 20.

In step S7, second communication device 20 may read the expression command from first communication device 10 and change the state of the multi-dimensional representation in the display.

Thereby an enhanced graphical service may be provided that enhances the user experience in a bandwidth-efficient manner.

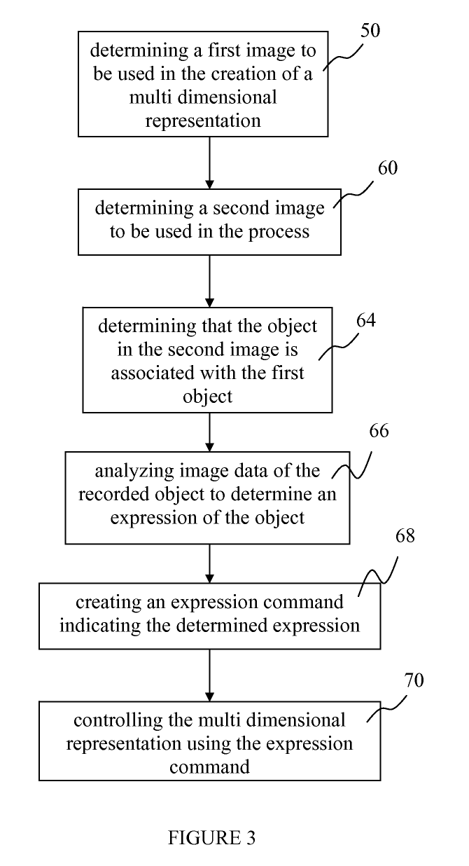

In FIG. 3, a schematic overview of a method implemented in first communication device 10 is shown.

In step 50, first communication device 10 may determine a first image of a first object to be used in a multi-dimensional representation, in which the multi-dimensional representation may be enabled to be set in at least two states, each representing an expression and to be controlled by commands.

In step 60, first communication device 10 may determine a second image of a second object to be used.

In step 64, first communication device 10 may determine if the second object in the determined second image is associated with the first object of the first image, for example, that the first object is the same as the second object.

In step 66, first communication device 10 may analyze the image data of the second image and determine an expression of the second object in the second image.

In step 68, first communication device 10 may create an expression command indicating the determined expression.

In step 70, the expression command may be used to control the multi-dimensional representation to be set in a state presenting the determined expression.

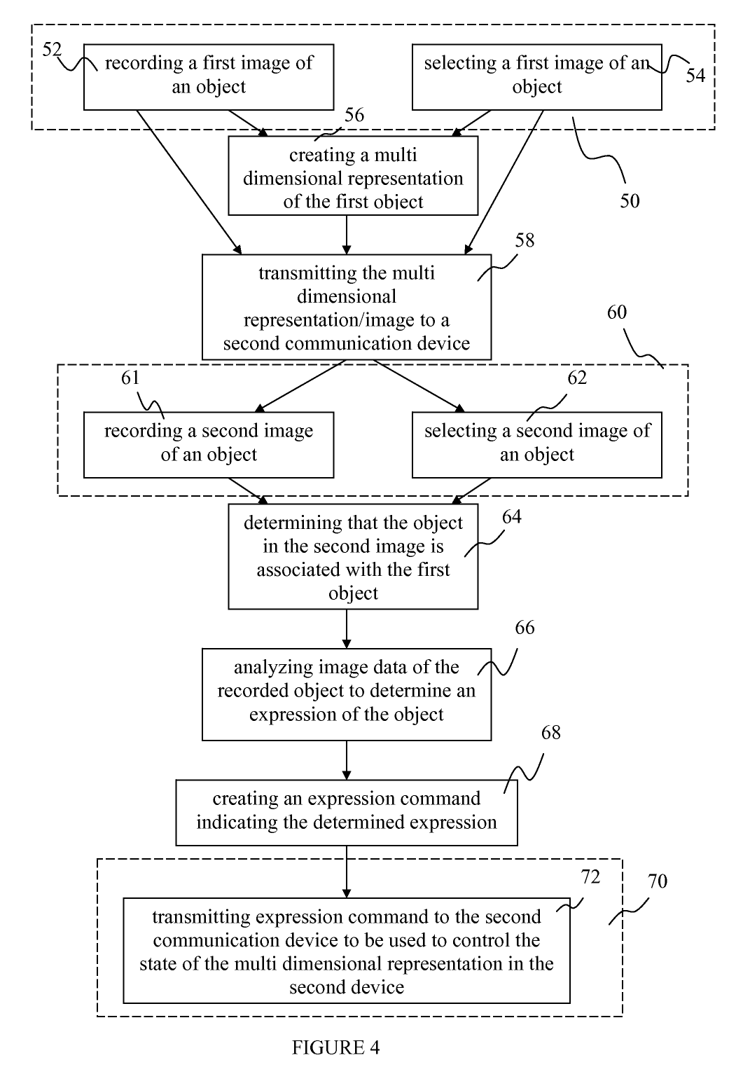

In FIG. 4, a schematic overview of embodiments of methods in first communication device 10 is shown.

In step 50, first communication device 10 may determine or identify a first image of a first object to be used to generate a multi-dimensional representation of the first object, in which the multi-dimensional representation may be enabled to be set in at least two states, each representing an expression and to be controlled by commands. Examples are shown in steps 52 and 54.

In step 52, the first image may be determined by recording an image of the first object using the first communication device.

In step 54, the first image may be determined by selecting an image stored in the first communication device.

Where the multi-dimensional representation is generated within the first communication device, as stated in step 56, first communication device 10 may generate a multi-dimensional representation of the first object using the first image. The first image may, in some embodiments, be represented as a three-dimensional model.

In step 58, first communication device 10 may transmit the multi-dimensional representation to second communication device 20.

In some embodiments of the invention, the multi-dimensional representation may be generated in second communication device 20, for example, in a server or the like, and first communication device 10 may transmit the first image of the first object.

In step 60, first communication device 10 may determine or identify a second image of an object to be used. Examples of determining the second image are disclosed optional steps 61 and 62.

In step 61, first communication device 10 may record the second image of a second object.

In step 62, first communication device 10 may select the second image of a second object from a plurality of stored images.

In step 64, first communication device 10 may determine if the second object in the determined second image is associated with the first object of the first image. This may be accomplished by comparing image data of the different images and based on the amount of matching parameters, such as eyes distance, mouth width, head shape, ear positions, or the like; it is determined whether the objects are associated.

In step 66, first communication device 10 may analyze the image data of the second image and determine an expression of the object. For example, the image data of the second image may be analyzed by comparing how the mouth ends are related to the mouth middle, how the eyebrows are positioned relative to the eyes, how the lips are positioned related to another, or the like.

It should be understood that step 66 may be performed before and/or concurrently with step 64.

In step 68, first communication device 10 may create an expression command indicating the determined expression. In some embodiments of the invention, the expression command may include a document of image changes, pixel changes, or the like.

In step 70, the expression command may be used to control the multi-dimensional representation to express the determined expression, for example, as in step 72.

In step 72, the first communication device may transmit the expression command to second communication device 20, to be used to control a state of the multi-dimensional representation in second communication device 20.

One or more of the embodiments described herein may provide a highly graphical emoticon control via a camera arrangement utilizing low bandwidth communication to present ones mood in, for example, chat services on all participants' user equipment.

It should also be appreciated that the method may be performed within first communication device 10, in which the multi-dimensional representation may be generated and rendered in first communication device 10. The determined expression data may be used to control the expression of the displayed multi-dimensional representation within first communication device 10.

To perform one or more of the methods described herein, first communication device 10 may be provided.

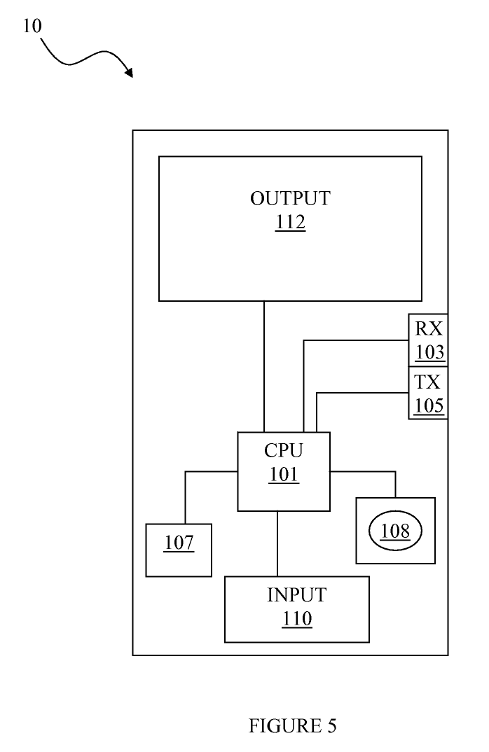

In FIG. 5, a schematic overview of first communication device 10 is shown.

First communication device 10 may include a control unit 101 configured to determine a first image of a first object to be used to generate a multi-dimensional representation of the first object. The multi-dimensional representation may be enabled to be set in at least two states, each representing an expression of the first object. The multi-dimensional representation may be controlled by commands to be set in the states.

Control unit 101 may include a single processing unit or a plurality of processing units.

Control unit 101 may also be configured to determine a second image of a second object to be used in the process to control the representation, and to determine whether the second object is associated with the first object. In some embodiments of the invention, control unit 101 may be configured to determine that the second object is associated with the first object by comparing image data of the second image and image data of the first image. Comparison may be performed, for example, by comparing mouth width, relative distance between the eyes, ear distances, head shape, or the like. Results of the comparison may be compared to, for example, a preset limit value of percentage of similarities or the like, and based on that, it may be determined whether the second image is associated with the first image.

Under these circumstances, control unit 101 may also be configured to analyze the second image to determine a first expression of the second object in the second image. Control unit 101 may, in some embodiments, be arranged to analyze image data of merely the second image to determine the first expression and/or by comparing it to image data of the first image.

Control unit 101 may be configured to create an expression command based on the determined first expression, in which the expression command may be configured to be used to control the multi-dimensional representation to be set in the first state presenting the determined first expression. In some embodiments, the expression command may include a document or the like indicating image data values arranged to alter or modify the state of the multi-dimensional representation. In some embodiments, the expression command may include data indicating that the expression command is associated with the multi-dimensional representation.

In some embodiments, first communication device 10 may also include an image recording unit 108 arranged to record the first image, and control unit 101 may be configured to determine that the recorded first image is to be used to generate the multi-dimensional representation. It should be appreciated that the image recording unit may be a still picture recording unit, a moving picture (e.g., video) recording unit, or the like.

Image recording unit 108 may also be configured to record a second recorded image of the second object, and control unit 101 may be configured to determine the second recorded image to be the second image to be used to control the presentation of the multi-dimensional representation.

First communication device 10 may, in some embodiments, include an input arrangement 110, an output arrangement 112, and a memory unit 107 arranged to have images stored thereon. Memory unit 107 may include a single or a plurality of internal or external memory units, being arranged to store first, second images, and/or other data, as well as applications to perform one or more of the methods described herein. Output arrangement 112 may be configured to disclose an image or a plurality of images retrieved from memory 107, and input arrangement 110 may be configured to be operated to select the image or one of the disclosed images as the first image. Output arrangement 112 may include, for example, a visual display, a speaker, or the like. Input arrangement 110 may include, for example, a keypad, a touch screen, or the like.

Input and output arrangements 110, 112 may be configured and operated similarly in embodiments where the second image is determined by manual selection.

In some embodiments, first communication device 10 may include control unit 101 that is configured to generate a multi-dimensional representation of the first object by using the first image.

First communication device 10 may, in some embodiments, also include a transmitting arrangement 105 configured to transmit the first image/the generated multi-dimensional representation of the first object to second communication device 20. Transmitting arrangement 105 may, in some embodiments, be configured to transmit the expression command to second communication device 20 to control the multi-dimensional representation to be set to the state expressing the determined expression.

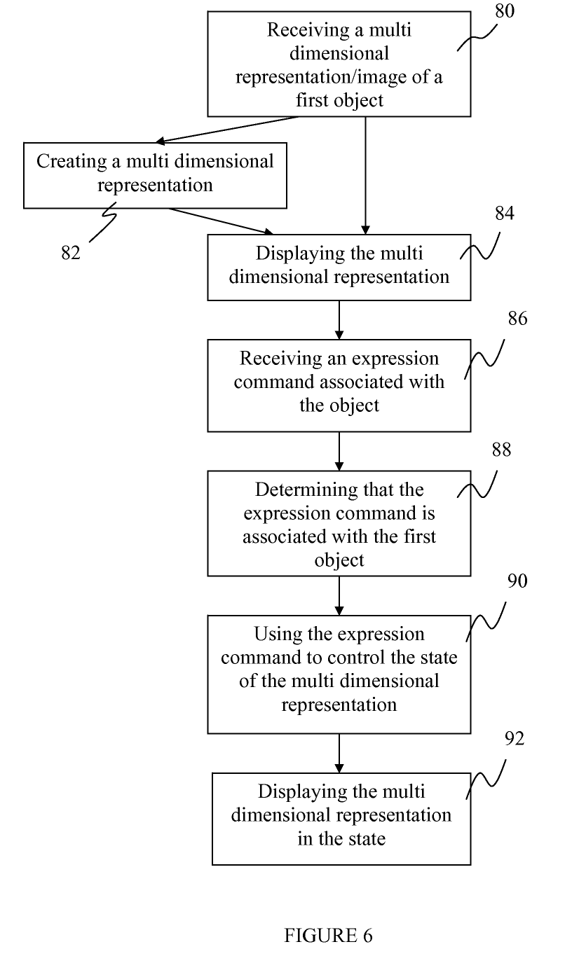

In FIG. 6, a method in a second communication device within a communications network is shown.

In step 80, second communication device 20 may receive image data. In some embodiments, the image data may include a first image of a first object, and in some embodiments the image data may include a multi-dimensional representation of the first object.

In step 82, the received image data may include the first image, and second communication device 20 may generate a multi-dimensional representation of the first object using the first image.

In step 84, the multi-dimensional representation may be displayed on a display of second communication device 20. If second communication device 20 includes a server or the like, the multi-dimensional representation may be presented/transmitted to one or more users connected to second communication device 20.

In step 86, second communication device 20 may receive an expression command. Data may also be received associating the expression command to the multi-dimensional representation/ the first object, or the like.

In step 88, second communication device 20 may determine that the received expression command is associated with the image data based on the received data.

In step 90, second communication device 20 may use the expression command to control the state of the multi-dimensional representation to be set in a set representing an expression.

In step 92, second communication device 20 renders the multi-dimensional representation in the state.

If second communication device 20 includes a server on network 45, the steps of displaying may not be executed.

To perform one or more of the methods described herein, second communication device 20 may be provided. Second communication device 20 may be user equipment or a node in communications network 45. For example, second communication device 20 may include a mobile phone, a PDA, a server, a computer in network 45, or the like.

Second communication device 20 may include a receiving arrangement 203 configured to receive image data of a first object from first communication device 10.

The image data may be used to provide a multi-dimensional representation of the first object enabled to be set in at least two states, each representing an expression and to be controlled by commands. In some embodiments, the image data may include a first image of the first object, and in some embodiments, the image data may include the multi-dimensional representation of the first object.

Receiving arrangement 203 may be configured to receive an expression command associated with the image data.

Second communication device 20 may also include control unit 201 that is configured to determine that the received expression command is associated with the image data and to use the expression command to control the state of the multi-dimensional representation from the image data. Control unit 201 may be configured to read data in the received expression command indicating that the expression command is associated with the image data.

Embodiments of the invention may include control unit 201 that is configured to generate the multi-dimensional representation of the first object by using the first image.

In some embodiments, second communication device 20 may include an output unit 209 arranged to display the multi-dimensional representation of the first object in the different states. Output arrangement 209 may include, for example, a display, a speaker, or the like.

Furthermore, second communication device 20 may, in some embodiments, include input arrangement 210, and a memory unit 207 configured to have image data/the multi-representation and/or the like, stored thereon. Input arrangement 210 may include, for example, a keypad, a touch screen and/or the like. Second communication device 20 may also include a transmitting arrangement 205 configured to transmit data back to first communication device 10 or the like.

A number of different embodiments are disclosed herein. One exemplary embodiment discloses user equipment that records an image, generates a 3-D model of the recorded image, transmits the 3-D model to second user equipment that displays and alters states of the 3-D model according to commands received from the first user equipment; user equipment that simply records the image, creates and displays the 3-D model, and alters the states of the 3-D model; user equipment that simply sends the image, and then commands to second user equipment that creates and alters the states of the image according to the received commands; and many more.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation, the scope of the invention being defined by the following claims.

What is claimed is:

1. In a first communication device, a method comprising:
determining a first image of a first object to be used to generate a multi-dimensional representation of the first object, wherein the multi-dimensional representation is enabled to be set in at least two states, each of the at least two state representing an expression to be controlled by an expression command;
determining a second image of a second object is to be used;
determining whether the second object in the second image is associated with the first object;
analyzing, when the second object is associated with the first object, the second image to determine a first expression of the second object;
creating the expression command based on the first expression; and
causing the multi-dimensional representation to be set in one of the at least two states based on the expression command.

2. The method of claim 1, wherein the determining the first image comprises recording the first image.

3. The method of claim 1, wherein the determining the first image comprises selecting the first image from a plurality of stored images.

4. The method of claim 1, further comprising:
transmitting the first image to a second communication device.

5. The method of claim 1, further comprising:
generating a multi-dimensional representation of the first object using the first image.

6. The method of claim 5, further comprising:
transmitting the multi-dimensional representation to a second communication device.

7. The method of claim 1, further comprising:
transmitting the expression command to a second communication device to present the multi-dimensional representation at the second communication device in the state representing the first expression.

8. The method of claim 1, wherein the determining that the second object is associated with the first object comprises comparing image data of the second image and image data of the first image.

9. The method of claim 1, wherein the determining the second image comprises recording a second image of the object using the first communication device.

10. The method of claim 1, wherein the recorded image is a still image or a video.

11. The method of claim 1, wherein the expression command is a document indicating image data values arranged to alter the state of the multi-dimensional representation.

12. A communication device comprising:
a control unit to:
determine a first image of an object to be used in generating a multi-dimensional representation, wherein the multi-dimensional representation is set in one of at least two states, each of the at least two states representing an expression to be controlled by an expression command,
determine a second image to be used;
determine whether the second image is associated with the first image;
analyze, when the second image is associated with the first image, the second image to determine a first expression of the second image, and
create the expression command based on the first expression, the expression command to configure the multi-dimensional representation in the one of the at least two states.

13. The communication device of claim 12, further comprising:
an image recording unit to record the first image.

14. The communication device of claim 12, further comprising:
an input arrangement;
an output arrangement; and
a memory unit to store a plurality images, wherein the output arrangement is configured to provide an image retrieved from the memory and the input arrangement is configured to select one of the stored images as the first image.

15. The communication device of claim 12, wherein the control unit is further configured to generate the multi-dimensional representation.

16. The communication device of claim 15, further comprising:
a transmitting arrangement to transmit at least one of the multi-dimensional representation or the first image to another communication device.

17. The communication device of claim 16, wherein the transmitting arrangement is configured to transmit the expression command to the second communication device to render the multi-dimensional representation at the second communication device in the one of the at least two states.

18. The communication device of claim 12, wherein the control unit is configured to determine whether the second image is associated with the first image by comparing image data of the second image and image data of the first image.

19. The communication device of claim 12, further comprising:
a recording unit to record a second recorded image of an object, wherein the control unit is configured to determine whether the second recorded image is the second image to be used.

20. The communication device of claim 12, wherein the expression command is a document indicating image data values causing the one of the at least two states of the multi-dimensional representation to be altered.

21. In a communication device within a communications network, a method comprising:
receiving image data of a first object, the image data being used to present a multi-dimensional representation of the first configurable in one of at least two states, each of the at least two states representing an expression to be controlled by an expression command;
receiving the expression command;
determining that the expression command is associated with the image data, and using the expression command to control the multi-dimensional representation from the image data to be set in a state representing an expression.

22. The method of claim 21, wherein the image data comprises a first image and the method further comprises the step of creating the multi-dimensional representation using the first image.

23. The method of claim 21, wherein the image data comprises the multi-dimensional representation.

24. The method of claim 21, wherein the method further comprises the step of displaying the multi-dimensional representation in the second communication device.

25. A communication device comprising:
a receiving arrangement to:
receive image data of a first object from a first communication device,
receive an expression command associated with the image data, and
generate, using the image data, a multi-dimensional representation of the first object enabled to assume one of at least two states, each of the at least two states representing an expression to be controlled by an expression commands; and
a control unit to:
determine whether the expression command is associated with the image data, and
use the expression command to control the state of the multi-dimensional representation from the image data.

26. The communication device of claim 25, wherein the image data comprises a first image of the first object, the control unit being further configured to generate the multi-dimensional representation using the first image.

27. The communication device of 25, wherein the image data comprises the multi-dimensional representation.

28. The communication device of claim 25, further comprising:
an output unit to display the multi-dimensional representation.
